(19) United States
(12) Patent Application Publication
(10) Pub. No.: US 2021/0233371 A1
(43) Pub. Date: Jul. 29, 2021

(54) AUTOMATIC VIDEO PRIVACY

(71) Applicant: Pelco, Inc., Fresno, CA (US)

(72) Inventors: Wilfred BRAKE, Timnath, CO (US); Davebo Sherwin RODRIGUES, Fresno, CA (US); Jonathan FARMER, Fresno, CA (US)

(21) Appl. No.: 16/972,329

(22) PCT Filed: May 17, 2019
(86) PCT No.: PCT/US2019/032854

§ 371 Date: Dec. 4, 2020

Related U.S. Application Data
(60) Provisional application No. 62/686,722, filed on Jun. 19, 2018.

(51) Int. Cl. G08B 13/196; G06F 16/71; G06F 16/783; G06F 16/787

(52) U.S. Cl. CPC G08B 13/19686; G06F 16/71; G08B 13/19667; G08B 13/19673; G06F 16/787; G06F 16/784

(57) ABSTRACT

A method for secure video surveillance with privacy features includes processing a video stream on a camera device to identify actionable privacy objects (APOs), extracting coordinates associated with the identified APOs to a metadata stream, and masking the identified APOs in the video stream. The video stream and the metadata stream are stored on at least one memory device associated with a remote video management system (VMS) that is communicatively coupled to the camera device. Selected ones of the identified APOs in the video stream are unmasked based on received user credentials, and using the extracted coordinates in the metadata stream, to create a modified video stream. The modified video stream is presented on a remote display device that is communicatively coupled to the remote VMS. A system for secure video surveillance is also provided.

### CROSS-REFERENCE TO RELATED APPLICATIONS

The present application claims priority to U.S. Provisional Application Ser. No. 62/686,722 which was filed on Jun. 19, 2018 and is incorporated by reference herein in its entirety.

### FIELD

This disclosure relates generally to video surveillance, and more particularly, to systems and methods related to secure video surveillance with privacy features.

### BACKGROUND

As is known, cameras are used in a variety of applications. One example application is in video surveillance applications in which cameras are used to monitor indoor and outdoor locations. Networks of cameras may be used to monitor a given area, such as the internal and external portion of an airport terminal.

### SUMMARY

Described herein are systems and methods related to secure video surveillance with privacy features. More particularly, in one aspect, a method for secure video surveillance with privacy features includes: processing a video stream on a camera device (e.g., from Pelco, Inc.) to identify actionable privacy objects (APOs), extracting coordinates associated with the identified APOs to a metadata stream, and masking the identified APOs in the video stream. The video stream and the metadata stream are stored on at least one memory device associated with a remote video management system (VMS) that is communicatively coupled to the camera device. Selected ones of the identified APOs in the video stream are unmasked (or otherwise exposed) based on received user credentials, and using the extracted coordinates and other visual data in the metadata stream, to create a modified video stream. The modified video stream is presented on a remote display device that is communicatively coupled to the remote VMS. In embodiments, the remote display device may be viewed by a user or operator (e.g., security personnel) for which the received user credentials are associated.

The above method, and the below described systems and methods, may include one or more of the following features either individually or in combination with other features in some embodiments. The APOs identified in the video stream may be (or include) user selected privacy objects. The identified APOs may correspond to faces of people, or vehicle license plates as a few examples. The identified APOs may correspond to substantially any other object which may merit privacy, for example, in accordance with local and national privacy laws (e.g., General Data Protection Regulation (GDPR) in Europe). In embodiments in which the identified APOs include faces of people, for example, the method may further include searching a database, using information in the metadata stream, to identify the people associated with the faces. The database may be (or include) a database of a cloud-based server that is remote from the VMS, for example. In some embodiments, presenting the modified video stream on the remote display device may include presenting select information associated with the select ones of the identified APOs corresponding to the identified people, on the remote display device. In some embodiments, APO's may be selected (or otherwise identified) by a user (e.g., of the remote VMS) using certain set locations in the video (like blocking out a video screen that remains in a constant location in the video stream), or by selecting features in the video that are automatically tracked like faces or license plates which move locations during the video capture.

In some embodiments, the video stream may be stored on a first memory device of the at least one memory device, and the metadata stream may be stored on a second memory device of the at least one memory device. In some embodiments, the first and second memory devices may be located at different geographical locations, for example, to provide an additional layer of security for the video data (i.e., the video and metadata streams) stored on the first and second memory devices. Additionally, in some embodiments the first and second memory devices are located at a same geographical location, for example, to increase accessibility to the video data.

In some embodiments, the identified APOs may be grouped into categories based on a predetermined set of criteria. In embodiments, only users having access to the categories can see the identified APOs associated with the categories when the modified video stream is presented on the remote display device. Prior to storing the video stream and the metadata stream, the video stream and the metadata stream may be encrypted on the camera device. The encrypted video stream and the encrypted metadata stream may be transmitted from the camera device to the remote VMS. In embodiments, the received user credentials are received from a user input device that is communicatively coupled to the remote VMS.

In some embodiments, the identified APOs are masked by applying an overlay over the identified APOs in the video stream, and the selected ones of the identified APOs are unmasked by removing the overlay from the selected ones of the identified APOs in the video stream. Additionally, in some embodiments the identified APOs are masked by removing the identified APOs from the video stream, and the selected ones of the identified APOs are unmasked by stitching together select information from the video stream and the metadata stream.

A system for secure video surveillance is also disclosed herein. In one aspect of this disclosure, a system for secure video surveillance includes at least one camera device and at least one remote VMS. The at least one camera device includes memory and one or more processors. The one or more processors of the at least one camera device are configured to: identify APOs in a video stream from the at least one camera device, extract coordinates associated with the identified APOs to a metadata stream, and mask the identified APOs in the video stream.

The at least one remote VMS is communicatively coupled to the at least one camera device and includes memory and one or more processors. The one or more processors of the at least one remote VMS are configured to: unmask selected ones of the identified APOs in the video stream based on received user credentials, and use the extracted coordinates in the metadata stream, to create a modified video stream. The one or more processors of the at least one remote VMS are also configured to present the modified video stream on a remote display device.

In some embodiments, the one or more processors of the at least one camera device are configured to transmit the video stream with the masked APOs to a first memory device located at a first geographical location. Additionally, in some embodiments the one or more processors of the at least one camera device are configured to transmit the metadata stream to a second memory device located at a second geographical location. In some embodiments, the one or more processors of the at least one remote VMS are configured to: access the video stream with the masked APOs from the first memory device, and access the metadata stream from the second memory device, to create the modified video stream.

In some embodiments, the one or more processors of the at least one camera device are configured to: access the video stream with the masked APOs from the first memory device and present the video stream with the masked APOs on the remote display device, for example, prior to receiving the user credentials.

As is known, in typical video surveillance applications, video data captured by video surveillance cameras are given to users or operators with substantially no modifications. This means that there is substantially no privacy, for example, for people in the video data who may not be aware they are being recorded. In embodiments, this invention provides a method to mask (e.g., “blur”) faces associated with the people in the video data, providing a means for operators to notice behavior of the people while protecting the privacy of the people. In other words, for places where privacy is expected, this invention can provide video surveillance while complying with privacy expectations.

In embodiments, example key new elements of this invention include: using face detection functionality in a camera device according to the disclosure to automatically mask (e.g., “blur”) faces, and providing face information in a metadata stream (which is separate from a video stream captured by and/or modified by the camera device). In embodiments, the face information can be encrypted “easily” for security. Other example key new elements of this invention include: a VMS of the disclosed video surveillance system recording video (with privacy features) and the faces or other identifying aspects separately, and the VMS providing either a private video with selected APOs presented, or a full video, with correct authentication.

Example applications in which the systems and methods described herein may be found suitable include applications subject to GDPR compliance. As is known, GDPR regulates how companies protect European Union citizens' personal data. As is also known, companies that fail to achieve GDPR compliance may be subject to stiff penalties and fines. Example privacy and data protection requirements of the GDPR include: requiring the consent of subjects for data processing, anonymizing collected data to protect privacy, providing data breach notifications, safely handling the transfer of data across borders, and requiring certain companies to appoint a data protection officer to oversee GDPR compliance.

One portion of the GDPR describes an ability for a person to be removed from all records. In accordance with various embodiments of this disclosure, as stored video data from the systems and methods disclosed herein may not contain identifiable information about a subject (e.g., a person), a company with embodiments of this feature may not have to go through extra efforts to comply with privacy orders, thereby providing a benefit of time and resource savings to such a company. Generally, standard test scenes are utilized to test and further improve analytics and other video features over time. This captured test video data may be captured by generic video equipment and may be used repeatedly for various periods of time. As the video stream data may not contain identifying features, in some cases it may be used for various periods of time (e.g. days, weeks, months, and/or years) without becoming a liability for privacy concerns.

Utilizing a process to separate video data from the camera from any identifiable characteristics of the video data allows a user or system to remove the identifiable aspects of the video data separately from the video data enabling additional benefits for use cases such as compliance to existing privacy laws, and may also be utilized for future compliance regulations or other applications.

It is understood that the systems and methods described herein may be found suitable in a wide variety of other applications than those discussed above. Other example applications may include, for example, airport terminal surveillance applications and education applications, particularly elementary education where juveniles are present. A school district or other managing authority may, for example, seek to keep student identities concealed. Financial institutions such as banks, and other businesses where confidentiality of a client is highly desirable, may also use this technology. Any metadata with the identifiable characteristics may be stored in such a way that only law enforcement or other authorized entities could ever handle and use the identifiable information. Municipal operations such as traffic operations may also benefit from embodiments of the disclosure. It should be appreciated these examples represent only a small number of embodiments possible and any application that required privacy or a method to abstract identifiable components of video data away are contemplated as part of this disclosure.

Additional objects and advantages will be set forth in part in the description which follows, and in part will be obvious from the description, or may be learned by practice of the present disclosure. At least some of these objects and advantages may be realized and attained by the elements and combinations particularly pointed out in the disclosure.

It is to be understood that both the foregoing general description and the following detailed description are exemplary and explanatory only and are not restrictive of the invention, as disclosed.

### BRIEF DESCRIPTION OF THE DRAWINGS

The foregoing features of the disclosure, as well as the disclosure itself may be more fully understood from the following detailed description of the drawings, in which:

FIG. 1 shows an example video surveillance system in accordance with embodiments of the disclosure;

FIG. 2 is a flowchart illustrating an example method for secure video surveillance with privacy features in accordance with embodiments of the disclosure;

FIG. 3 shows an example scene captured by a video surveillance camera device without privacy features according to the disclosure enabled;

FIG. 4 shows example actionable privacy objects (APOs) which may be identified in the scene shown in FIG. 3;

FIG. 5 shows an example scene captured by a video surveillance camera device with example privacy features according to the disclosure enabled;

FIG. 6 shows an example scene captured by a video surveillance camera device with selected APOs of the scene shown in FIG. 5 unmasked in accordance with example privacy features according to the disclosure;

FIG. 7 shows an example grouping of APOs into categories in accordance with embodiments of the disclosure; and

FIG. 8 shows another example grouping of APOs into categories in accordance with embodiments of the disclosure.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

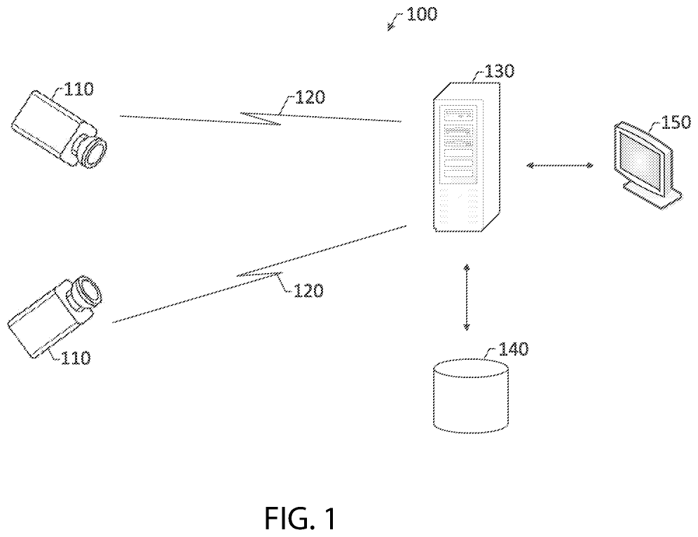

Referring to FIG. 1, an example video surveillance system 100 according to the disclosure is shown including at least one camera device 110 (here, two cameras 110) and at least one remote video management system (VMS) 130 (here, one VMS 130). The at least one camera 110 may be positioned to monitor one or more areas interior to or exterior from a building (e.g., an airport terminal) to which the at least one camera 110 is coupled. Additionally, the at least one VMS 130 may be configured to receive video data (video and metadata streams, as will be discussed further below) from the at least one camera 110. In embodiments, the at least one camera 110 is communicatively coupled to the at least one VMS 130 through a communications network, such as, a local area network, a wide area network, a combination thereof, or the like. Additionally, in embodiments the at least one camera 110 is communicatively coupled to the at least one VMS 130 through a wired or wireless link, such as link 130 shown.

The at least one VMS 130 is communicatively coupled to at least one memory device 140 (here, one memory device 140) (e.g., a database) and to a remote display device 150 (e.g., a computer monitor) in the example embodiment shown. The at least one memory device 140 may be configured to store video data received from the at least one camera 110. Additionally, the at least one VMS 130 may be configured to present select camera video data, and associated information, via the remote display device 150, based, at least in part, on a user's (e.g., security personnel) access credentials. The user's access credentials may be received, for example, from a user input device (e.g., a keyboard, biometric recognition technology, video recognition devices, etc.) (not shown) communicatively coupled to the VMS 130. In some embodiments, the remote display device 150 corresponds to a display or screen of the at least one VMS 130. Additionally, in some embodiments the remote display device 150 corresponds to a display or screen of a client device that is communicatively coupled to the at least one VMS 130. The client device can be a computing device, for example, a desktop computer, a laptop computer, a handheld computer, a tablet computer, a smart phone, and/or the like. The client device can include or be coupled to the user input device for receiving the user's access credentials.

In some embodiments, the at least one memory device 140 to which the at least one VMS 130 is coupled is a memory device of the at least one VMS 130. In other embodiments, the at least one memory device 140 is an external memory device, as shown. In some embodiments, the at least one memory device 140 includes a plurality of memory devices. For example, in some embodiments the at least one memory device 140 includes at least a first memory device and a second memory device. The first memory device may be configured to store a first portion of video data received from the at least one camera device 140, for example, a video stream of the video data. Additionally, the second memory device may be configured to store a second portion of video data received from the at least one camera device 140, for example, a metadata stream of the video data. In embodiments, the first and second memory devices are located at a same geographical location. Additionally, in embodiments the first and second memory devices are located at different geographical locations, for example, to provide an additional layer of security for the video data stored on the first and second memory devices.

Through the storage of the privacy data (i.e. data combined with video data which presents a complete video image without APO's), an additional level of security to one's privacy may be gained. A secondary storage location may be set up where only authorized personnel are able to examine the data. In another embodiment, a physical location of this data may be secured by different locks and/or other security devices to secure the data from unauthorized physical access. Privacy data may also be encrypted so that even physical access may not be enough to view the private data. It should be appreciated these examples represent only a small number of embodiments possible and may other embodiments regarding data storage security are contemplated.

The at least one VMS 130 to which the at least one memory device 140 is communicatively coupled may include a computer device, e.g., a personal computer, a laptop, a server, a tablet, a handheld device, etc., or a computing device having one or more processors and a memory with computer code instructions stored thereon. In embodiments, the computer or computing device may be a local device, for example, on the premises of the building which the at least one camera 110 is positioned to monitor, or a remote device, for example, a cloud-based device.

The at least one camera 110, which may be from the Optera, Spectra and/or Espirit family of cameras by Pelco, Inc., for example, may include one or more processors (not shown) which may be configured to provide a number of functions. For example, the camera processors may perform image processing, such as motion detection, on video streams captured by the at least one camera 110. Other example methods such as computer vision and/or deep learning analytics are also contemplated as part of this disclosure. In embodiments, the at least one camera 110 is configured to process a video stream captured by the at least one camera 110 on the at least one camera 110 to identify actionable privacy objects (APOs) in the video stream. The APOs may, for example, correspond to faces of people, vehicle license plates, and/or substantially any other object which may merit privacy, for example, in accordance with local and national privacy laws (e.g., General Data Protection Regulation (GDPR) in Europe).

It should be appreciated, APO's may include a computer screen in the video view that may be used by the public for private matters like banking, or social media updates.

Another APO may be a keyboard attached to a public computer. A user or system may be able to recreate a password by observation of the video. An APO would substantially reduce the opportunity for such sensitive information to be harvested from the video data.

In some embodiments, the APOs are user configured APOs. In embodiments, parameters (e.g., features) associated with the user configured APOs may be adjusted or tuned, for example, from time to time, in response to user input (e.g., from an authorized user through a user input device). Tuning of the APO parameters may be desirable, for example, to account for changes in privacy laws. For example, a user configured APO initially associated with faces of a particular category of people (e.g., children) that is afforded a first level of privacy, may be expanded to include faces of another category of people (e.g., adults) that was previously afforded a second, lower level of privacy, and is now afforded the first level of privacy due to changes in privacy laws.

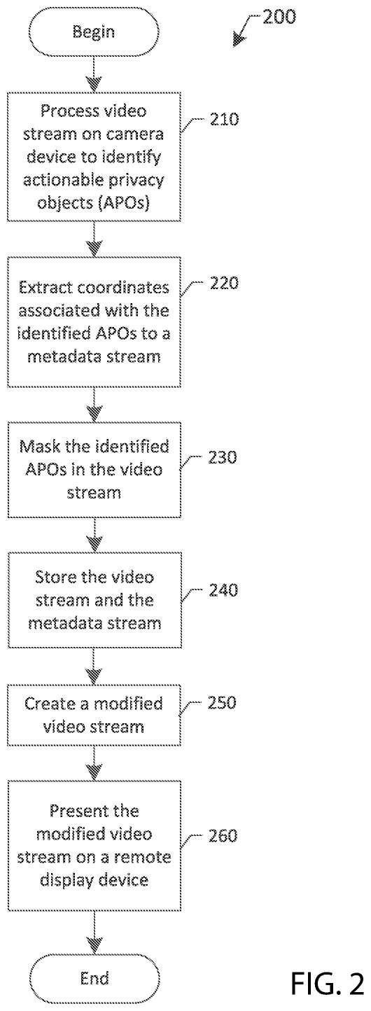

An example method for secure video surveillance with privacy features, which includes identifying APOs, is discussed below in connection with FIG. 2. However, however let it suffice here to say that the at least one camera 110 may identify the APOs based on one or more parameters associated with the APOs.

Though using the camera to create the APOs is the most elegant solution, another computing device could be used to create the APOs. This might be advantageous to customers who have legacy equipment that is difficult to replace. This computing device would exist between 110 and 130 in your diagram.

In embodiments, the at least one camera 110 may also be configured to process the video stream to extract coordinates associated with the identified APOs, and mask the identified APOs in the video stream. The extracted coordinates may be provided in a metadata steam, which along with the video stream with the masked APOs, may be transmitted for storage on the at least one memory device 140.

In some embodiments, the video stream may be stored on a memory device associated with the at least one camera 110 prior to and/or after the processing by the at least one camera 110. In some embodiments, the memory device associated with the at least one camera 110 may be a memory device of the at least one camera 110. In other embodiments, the memory device associated with the at least one camera 110 may be an external memory device.

Additional aspects of video surveillance systems in accordance with various embodiments of the disclosure are discussed further in connection with figures below.

Referring to FIG. 2, a flowchart (or flow diagram) 200 is shown. Rectangular elements (typified by element 210), as may be referred to herein as “processing blocks,” may represent computer software instructions or groups of instructions. The processing blocks can represent steps performed by functionally equivalent circuits such as a digital signal processor circuit or an application specific integrated circuit (ASIC).

The flowchart does not depict the syntax of any particular programming language. Rather, the flowchart illustrates the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied. Thus, unless otherwise stated, the blocks described below are unordered; meaning that, when possible, the blocks can be performed in any convenient or desirable order including that sequential blocks can be performed simultaneously and vice versa.

Referring to FIG. 2, a flowchart 200 illustrates an example method for secure video surveillance with privacy features that can be implemented, for example, using video surveillance system 100 shown in FIG. 1.

As illustrated in FIG. 2, the method begins at block 210, where a camera device (e.g., 110, shown in FIG. 1) processes a video stream captured by the camera device to identify actionable privacy objects (APOs) in the video stream. In embodiments, the APOs (e.g., 312a, 313a, 314a, 315a, 316a, shown in FIG. 4, as will be discussed below) are identified based on a predetermined set of criteria (or parameters) associated with the APOs. For example, in one embodiment the APOs correspond to faces of people, and the APOs are identified based on a predetermined set of criteria that is suitable for detecting faces of people (as opposed to hands and feet of people). As another example, in one embodiment the APOs correspond to vehicle license plates, and the APOs are identified based on a predetermined set of criteria that is suitable for detecting vehicle license plates (as opposed to other vehicle features). In some embodiments, the APOs may further be identified based on motion, or temporal variation, information derived from the video stream. It should be appreciated APOs may also be static such as a video screen that is always in the same place, or a door to a private facility which may show personal information when a door or window is open. APOs may also be identified utilizing analytics technology such as face detection, age detection, gender detection, etc. In some embodiments, the camera device may include more than one camera device (e.g., two cameras, as shown in FIG. 1), and the cameras devices may communicate with each other to identify the APOs at block 210. It is understood that the APOs may be identified using techniques known to those of ordinary skill in the art, including those described, for example, in U.S. Pat. No. 9,639,747 entitled “Online learning method for people detection and counting for retail stores,” which is assigned to the assignee of the present disclosure and incorporated herein by reference in its entirety.

At block 220, the camera device extracts coordinates associated with the identified APOs to a metadata stream, for example, as the camera device identifies the APOs at block 210. This process can occur simultaneously with the APO identification in some embodiments, or after the APO identification in other embodiments. In embodiments, the metadata stream includes coordinates to re-create original video content associated with the identified APOs. These coordinates may include spatial information to replace privacy areas associated with the identified APOs with real video captured, and time information so it matches the correct video frame. In embodiments, these coordinates can be simple rectangles, or more complicated polygons. This can be represented by pixel counts from the top left corner which will give exact coordinates. The time information can be matched using the standard time-stamping capabilities included in video (i.e., every video frame contains a wall clock time that can be matched with the metadata). In embodiment, the metadata stream can be encrypted, for example, to provide an additional layer of security, using standard techniques like transport layer security (TLS), or by proprietary methods. Since privacy data is usually a smaller subset of the entire video image, it's computational cost to encrypt could be substantially less that attempting to encrypt the entire video contents. This may provide a cost advantage over encrypting an entire video stream for privacy concerns.

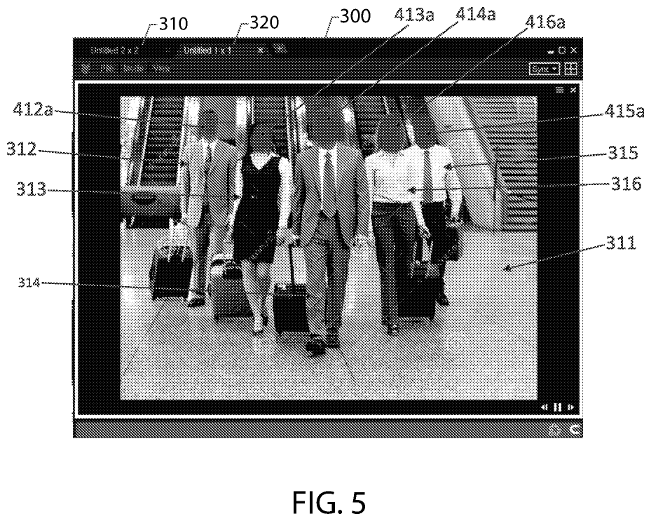

At block 230, the camera device masks the identified APOs in the video stream. As one example, the camera device may “obliterate” the video data in privacy areas (e.g., 412a, 413a, 414a, 415a, 416a, shown in FIG. 5, as will be discussed below) associated with the identified APOs. For example, the camera device may write over the privacy area with a gray pattern, a color like black, or some other ‘picture’, or remove imagery associated with the identified APOs from the video stream using subtractive techniques known to those of ordinary skill in the art. As another example, the camera device may apply a blurring effect on the privacy area using techniques that are known to those of ordinary skill in the art. This makes it impossible to recreate the video with the original video data in the privacy area from the video stream itself. In other words, in embodiments the video can only be recreated using the video stream and the metadata stream from block 220. In embodiments, overlay (or additive editing) techniques may additionally or alternatively be used. For example, the privacy areas associated with the identified APOs may be overlayed with a predetermined overlay (e.g., a gray pattern, a color like black, or some other ‘picture’). Refinements to the video stream may also be utilized, such as edge blending for one example, to enhance the aesthetics, readability, and/or functionality of the output.

In embodiments in which an overlay is applied, the overlay can move or change in size, shape or dimension as the position(s) of the identified APOs changes, or the viewing area of the camera changes (and aspect of video changes) under automatic control or by a human operator. The overlay can be provided, for example, by calculating or determining the shape of the overlay based on the shape of the identified APOs, and rendering the overlay on a corresponding position on the video stream using a computer graphic rendering application (e.g., OpenGL, Direct3D, and so forth).

It is understood that the overlay may take a variety of forms, and in some embodiments one or more properties associated with the overlay are user configurable. For example, in embodiments the overlay properties include a type of overlay (e.g., picture, blurring, etc.) and/or a color (e.g., red, blue, white, etc.) of the overlay, and a user may configure the type and/or color of the overlay, for example, through a user interface of the remote display device. Other attributes of the overlay (e.g., thickness, dashed or dotted lines) may also be configurable.

In one example implementation, an output of blocks 210, 220, 230 includes a first track including the video stream with the APOs removed or masked, a second track with an audio stream associated with the video stream, and a third track including a metadata stream with general information about the stream and other information associated with the APOs (e.g., objects with their respective coordinates, as discussed above).

At block 240, the video stream and the metadata stream (and, in some cases, an audio stream and other tracks or streams) are stored on at least one memory device (e.g., 140, shown in FIG. 1) associated with a remote video management system (VMS) (e.g., 130, shown in FIG. 1). In embodiments, the video stream and the metadata stream are transmitted from the camera device to the at least one memory device via the video management system, for example. In some embodiments, at least one of the video stream and the metadata stream is encoded and/or encrypted on the camera device prior to transmission to the VMS and/or the at least one memory device.

At block 250, selected ones of the identified APOs in the video stream are unmasked based on received user credentials, and using the extracted coordinates and video data in the metadata stream, to create a modified video stream. For example, while the video stream is decoded, the metadata stream may be decoded, and the APOs may be decoded. If the received user credentials pass for a specific APO category, the APO may be overlayed on top of the video stream at the coordinates associated with the APO (as may be obtained from the metadata stream). As the APO changes its position (e.g., due to normal movement), the coordinates associated with the APO may be adjusted or recalculated based on the updated position using techniques known to those of ordinary skill in the art.

In some embodiments, the modified video stream is substantially the same as the original video stream. For example, in embodiments in which the received user credentials are for a user with full-access privileges (e.g., an administrator), the selected ones of the identified APOs may correspond to all (or substantially all) of the identified APOs, and the modified video stream may be substantially the same as the original captured video.

In other embodiments, the modified video stream is substantially different from the original video stream. For example, in embodiments in which the received user credentials are for a user with limited access privileges (e.g., an employee), the selected ones of the identified APOs may correspond to a reduced number of the identified APOs, and the modified video stream may be substantially different from the original video stream.

In GDPR compliance (“right to be forgotten”) applications, for example, there may be an option to remove any personally identifiable metadata that is stored, and used to produce to modified video stream. As identifiable parts of the video may be stored away from the remainder of the video, this may be deleted separately from the video with the APOs obliterated.

At block 260, the modified video stream is presented on a remote display device (e.g., 150, shown in FIG. 1) that is communicatively coupled to the remote VMS, for example, for viewing by a user (e.g., security personnel).

After block 260, the method may end. In embodiments, the method may be repeated again in response to user input, or automatically in response to one or more predetermined conditions. For example, the method may be repeated again after a detected period of inactivity by a user viewing the remote display device. Additionally, the method may be repeated again in response the user logging out of a user input device associated with the remote display device, for example, after the user's scheduled work shift, and with a new user taking over monitoring the remote display device.

Embodiments of these process may be repeated if it is determined that more data belongs in the APO. In such a case, the data may be modified by a different computational device than the camera. Various stages if iterative processing is contemplated in elements of this disclosure.

It is understood that method 200 may include one or more additional blocks in some

embodiments. For example, the method 200 may include taking one or more actions in response to events occurring in the modified video stream presented at block 260. For example, the modified video stream may be processed (e.g., on a remote VMS) to identify actionable events in the modified video stream, and the system(s) on which the method 200 is implemented (e.g., video surveillance system 100, shown in FIG. 1) may take one or more actions in response to the identified actionable events. The identified actionable events may include, for example, crimes (e.g., theft) committed by people presented in the modified video stream, or car accidents resulting from vehicles presented in the modified video stream. The actions taken in response to the actionable events may include, for example,
recording identifying information (e.g., clothing type) of the committer (or committers) of a crime, locking or shutting a door in a facility in which the crime is committed to prevent the committer(s) of the crime from leaving the facility, and/or deploying security personnel to apprehend the committer(s) of the crime. The actions may also include detecting and recording license plates (and/or other identify information such as car make, color, etc.) of vehicles involved in a car accident, and/or detecting and recording accident type, who is responsible for the accident, etc. The actions may further include deploying a police officer, ambulance and/or a tow truck to the scene of the accident, as another example.

It is understood that secure video surveillance with privacy features is the focus of this invention, and many other systems and methods may incorporate the various features of the invention in a wide variety of applications and use cases.

Additional aspects of the systems and methods disclosed herein will be appreciated from discussions below.

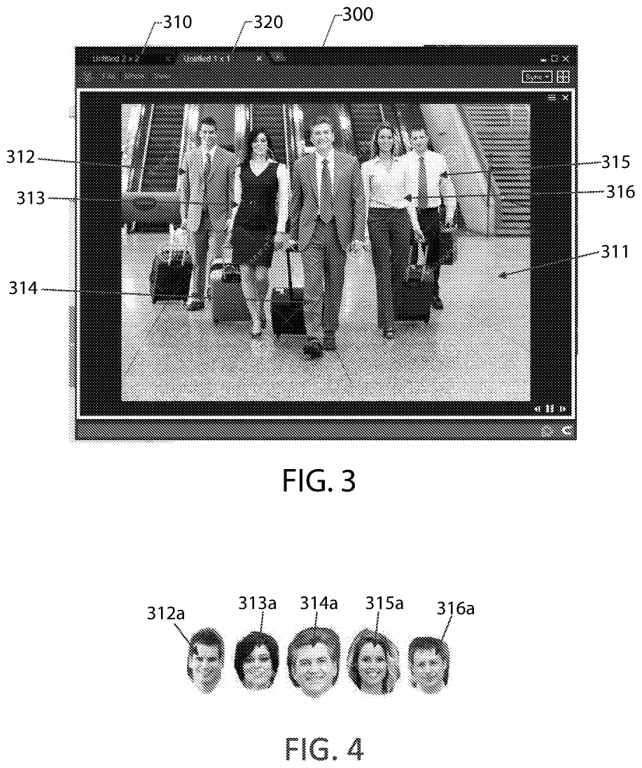

Referring to FIG. 3, an example scene 311 captured by a video surveillance camera device (e.g., 110, shown in FIG. 1) without privacy features according to the disclosure enabled is shown. In the illustrated embodiment, the scene 311 is shown in a display interface 300 (e.g., of remote display device 150, shown in FIG. 1), with the display interface 300 capable of showing scenes captured by a plurality of video surveillance camera device, for example, by a user selecting tabs 310, 320 of the display interface 300. Tab 310 may show a scene (not shown) captured by a first camera of the plurality of cameras, and tab 320 may show a scene 311 captured by a second camera of the plurality of cameras.

As illustrated, a plurality of people (as denoted by reference designators 312, 313, 314, 315, 316) are shown in scene 311, which in embodiments may correspond to an area of airport terminal which the video surveillance camera is configured to monitor. As also illustrated, the plurality of people have substantially no privacy. In other words, substantially everything about the people is shown in the scene 311, including identifying features such as their faces. Security, police, and other miscellaneous people can see everything in the scene 311, even if there is nothing suspicious or criminal happening. In accordance with various aspects of the disclosure, at least some level of privacy may be desirable (or even required by privacy laws).

Referring to FIG. 4, example APOs which may be identified in the scene 311 shown in FIG. 3 in order to provide a level of privacy in accordance with embodiments of the disclosure are shown. In particular, faces 312a, 313a, 314a, 315a, 316a associated with the plurality of people 312, 313, 314, 315, 316 are identified as APOs according to the disclosure (e.g., at block 210 of the method shown in FIG. 2). Additionally, coordinates associated with the identified APOs 312a, 313a, 314a, 315a, 316a may be extracted to a metadata stream (e.g., at block 220 of the method shown in FIG. 2). In embodiments, the metadata contains information necessary to transpose on a camera image like coordinates and rotation. Additionally, in embodiments the metadata stream will be much smaller than the original picture (e.g., as shown in FIG. 4). This makes the metadata small, which makes metadata encryption easier to do on the camera, for example.

In some embodiments, information associated with the identified APOs may be compared to information stored in a database to further identify the APOs. For example, in embodiments various characteristics (e.g., facial features) of the identified APOs (e.g., faces) may be compared to information stored in a database, to further identify the APO (e.g., associate the APO with a particular person). The database may be a database associated with the video management system, or correspond to database a database of a remote (e.g., a cloud-based) server, for example.

Referring to FIG. 5, the identified APOs 312a, 313a, 314a, 315a, 316a shown in FIG. 4 may be automatically masked to add a level of privacy to the scene 311 (e.g., at a block 230 of the method shown in FIG. 2), as indicated by reference designators 412a, 413a, 414a, 415a, 416a. As discussed above in connection with FIG. 2, in some embodiments the identified APOs are masked using subtractive techniques. Additionally, as discussed above in connection with FIG. 2, in some embodiments the identified APOs are masking using additive (e.g., overlay) techniques. In the example embodiment shown, faces are blurred the people associated with the faces are anonymous. However, where the people go and what the people do is discernable by a user (e.g., security) viewing the scene 311.

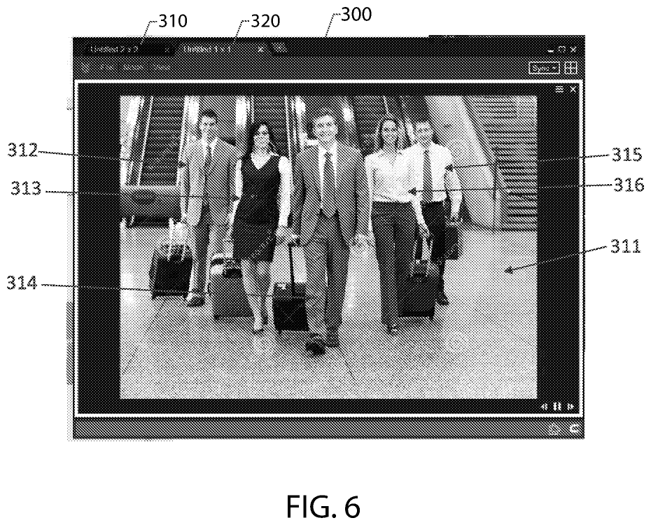

Referring to FIG. 6, selected ones of the identified APOs are unmasked based on received user credentials, and using the extracted coordinates in the metadata stream, to create a modified video stream (e.g., at block 250 of the method shown in FIG. 2), as shown by scene 311. In embodiments, the modified video stream is presented on a remote display device (e.g., at bock 260 of the method shown in FIG. 2). As discussed above in connection with FIG. 2, for example, in some embodiments the selected ones of the identified APOs may be unmasked by “stitching” together information from the video stream (e.g., shown in FIG. 5) and the metadata stream (e.g., as may be obtained from the coordinate information extraction, as discussed above in connection with FIG. 4). In other embodiments, the selected ones of the identified APOs may be unmasked by removing the overlay that was applied over the identified APOs.

In the illustrated embodiment, the modified video stream is the same as the original video stream shown in FIG. 3. In embodiments, such may be indicative of the user's credentials enabling access to all of the identified APOs. In some embodiments, less than all of the identified APOs may be shown in the modified video stream.

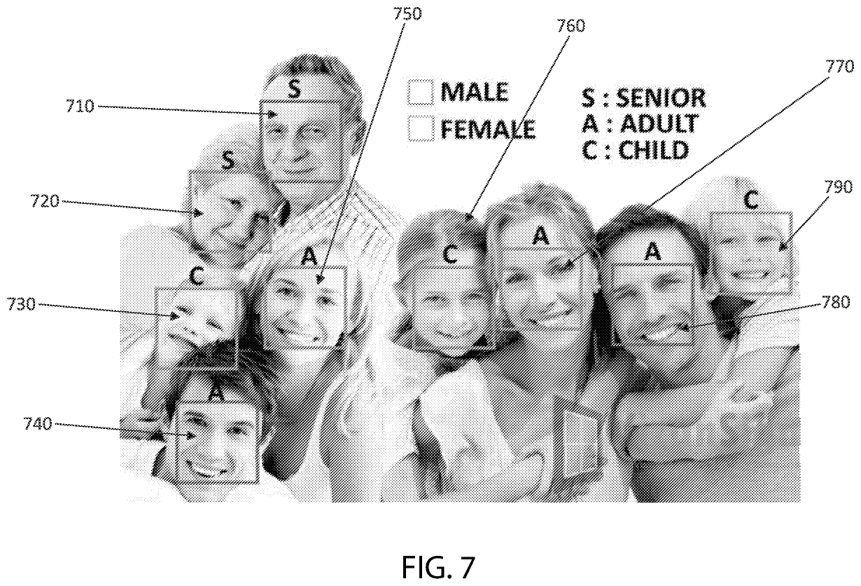

Referring to FIG. 7, example APOs 710, 720, 730, 740, 750, 760, 770, 780, 790 (e.g., faces of people) in accordance with embodiments of the disclosure are shown. In embodiments, the APOs 710, 720, 730, 740, 750, 760, 770, 780, 790 may be grouped based on a predetermined set of criteria (or one or more characteristics) associated with the APOs. For example, in the illustrated embodiment the APOs 710, 720, 730, 740, 750, 760, 770, 780, 790 may be grouped based on gender (male or female) and age (senior, adult, child). In embodiments, only users having access privileges to the categories can see the identified APOs (e.g., APOs that are identified at block 210 of the method shown in FIG. 2) associated with the categories when the modified video stream is presented on the remote display device. In one aspect of the disclosure, such provides another layer of privacy for individuals captured in a surveillance camera video stream

In embodiments, the categories are user configured categories. In embodiments, parameters associated with the user configured categories may adjusted or tuned, for example, from time to time, in response to user input (e.g., from an authorized user through a user device). Tuning of the categories may be desirable, for example, to account for changes in privacy laws. For example, a user configured APO initially associated with faces of a particular category of people (e.g., children) that is afforded a first level of privacy, may be expanded to include faces of another category of people (e.g., adults) that was previously afforded a second, lower level of privacy, and is now afforded the first level of privacy due to changes in privacy laws. In embodiments, new or updated categories may also be generated (or adjusted or tuned) in response to user input (e.g., from an authorized user through a user device). It should be appreciated processing of video data may be iterative. Existing video may be reprocessed to add, remove, or otherwise edit APO's. In such cases, the video data may be re-processed to add, remove, or otherwise edit APO's, any changed privacy data would be included to the metadata.

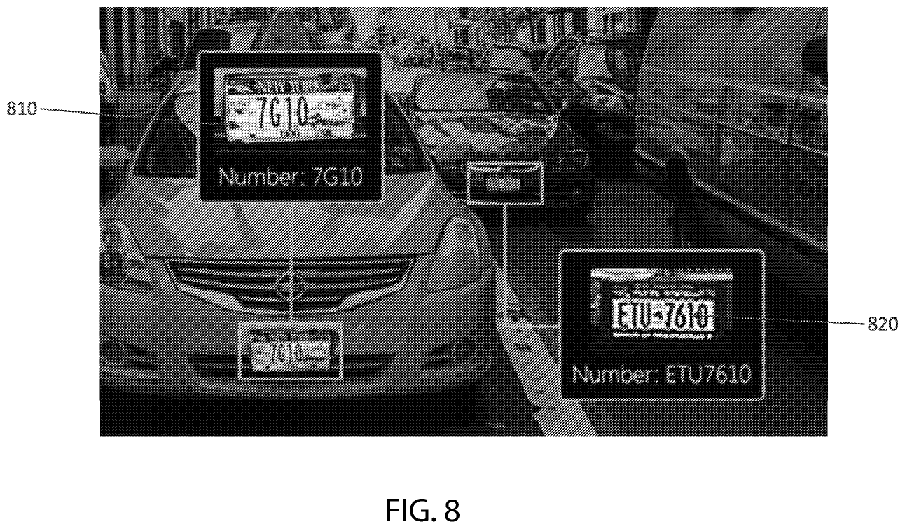

Referring to FIG. 8, example APOs 810. 820 in accordance with other embodiments of the disclosure are shown. In the illustrated embodiment, the APOs 810, 820 correspond to vehicle license plates. In some embodiments, the APOs 810, 820 may be grouped into categories, for example, a first category associated with taxi license plates and a second category associated with private vehicle license plates. APO 810 may be grouped into the first category and APO 820 may be grouped into the second category. In the illustrated embodiment, grouping of the license plates into categories may be desirable, for example, when taxis are afforded a first level of privacy, and private vehicles are afforded a second level of privacy that is different than the first level of privacy. A user viewing a video surveillance system remote display device, for example, may be able to see license plates associated with selected categories (e.g., only taxi license plates) based on the user's credentials using the systems and methods described in connection with figures above. In some embodiments, information associated with the license plates (e.g., license plate number, state of license plate, expiration date, etc.) can be verified by comparing information obtained from the video stream with information from other sources. For example, a taxi cab identified in the video stream may have a Bluetooth or RFID identifier that can be used in conjunction with the video stream to verify accuracy. The Bluetooth or RFID identifier (or other source) may be in communication with the camera device(s) responsible for capturing the video stream, for example.

As described above and as will be appreciated by those of ordinary skill in the art, embodiments of the disclosure herein may be configured as a system, method, or combination thereof. Accordingly, embodiments of the present disclosure may be comprised of various means including hardware, software, firmware or any combination thereof.

It is to be appreciated that the concepts, systems, circuits and techniques sought to be protected herein are not limited to use in particular applications (e.g., commercial surveillance applications) but rather, may be useful in substantially any application where secure video surveillance with privacy features is desired.

Having described preferred embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above.

Accordingly, it is submitted that that scope of the patent should not be limited to the described embodiments but rather should be limited only by the spirit and scope of the following claims.

What is claimed is:

1. A method for secure video surveillance with privacy features, the method comprising:
processing a video stream on a camera device to identify actionable privacy objects (APOs);
extracting coordinates associated with the identified APOs to a metadata stream;
masking the identified APOs in the video stream;
storing the video stream and the metadata stream on at least one memory device associated with a remote video management system (VMS), the remote VMS communicatively coupled to the camera device;
unmasking selected ones of the identified APOs in the video stream based on received user credentials, and using the extracted coordinates in the metadata stream, to create a modified video stream; and
presenting the modified video stream on a remote display device, the remote display device communicatively coupled to the remote VMS.

2. The method of claim 1 wherein the APOs are user selected privacy objects or privacy areas.

3. The method of claim 1 wherein the APOs correspond to faces of people, or vehicle license plates.

4. The method of claim 1 wherein the identified APOs comprise faces of people, and the method further comprises:
searching a database, using information in the metadata stream, to identify the people associated with the faces.

5. The method of claim 4 wherein the database is a database of a cloud-based server, and the cloud-based server database is remote from the VMS.

6. The method of claim 4 wherein presenting the modified video stream on the remote display device further comprises presenting select information associated with the select ones of the identified APOs corresponding to the identified people, on the remote display device.

7. The method of claim 1 wherein the video stream is stored on a first memory device of the at least one memory device, and the metadata stream is stored on a second memory device of the at least one memory device.

8. The method of claim 7 wherein the first and second memory devices are located at different geographical locations.

9. The method of claim 7 wherein the first and second memory devices are located at a same geographical location.

10. The method of claim 1 further comprising:
grouping the identified APOs into categories based on a predetermined set of criteria, wherein only users having access to the categories can see the identified APOs associated with the categories when the modified video stream is presented on the remote display device.

11. The method of claim 1 further comprising:
prior to storing the video stream and the metadata stream, encrypting the video stream and the metadata stream on the camera device; and
transmitting the encrypted video stream and the encrypted metadata stream from the camera device to the remote VMS.

12. The method of claim 1 wherein the received user credentials are received from a user input device that is communicatively coupled to the remote VMS.

13. The method of claim 1 wherein the identified APOs are masked by applying an overlay over the identified APOs in the video stream.

14. The method of claim 13 wherein the selected ones of the identified APOs are unmasked by removing the overlay from the selected ones of the identified APOs in the video stream.

15. The method of claim 1 wherein the identified APOs are masked by removing the identified APOs from the video stream.

16. The method of claim 1 wherein the selected ones of the identified APOs are unmasked by stitching together select information from the video stream and the metadata stream.

17. A system for secure video surveillance, comprising:
at least one camera device, including;
memory; and
one or more processors configured to:
identify actionable privacy objects (APOs) in a video stream from the at least one camera device;
extract coordinates associated with the identified APOs to a metadata stream; and
mask the identified APOs in the video stream;
a remote video management system (VMS) communicatively coupled to the at least one camera device, the remote VMS including:
memory; and
one or more processors configured to:
unmask selected ones of the identified APOs in the video stream based on received user credentials, and use the extracted coordinates in the metadata stream, to create a modified video stream; and
present the modified video stream on a remote display device.

18. The system of claim 17 wherein the one or more processors of the at least one camera device are configured to:
transmit the video stream with the masked APOs to a first memory device located at a first geographical location; and
transmit the metadata stream to a second memory device located at a second geographical location.

19. The system of claim 18 wherein the one or more processors of the remote VMS are configured to:
access the video stream with the masked APOs from the first memory device; and
access the metadata stream from the second memory device to create the modified video stream.

20. The system of claim 17 wherein the one or more processors of the at least one camera device are configured to:
access the video stream with the masked APOs from the first memory device; and
present the video stream with the masked APOs on the remote display device prior to receiving the user credentials.
